(19) United States
(12) Patent Application Publication
(10) Pub. No.: US 2008/0056647 A1
(43) Pub. Date: Mar. 6, 2008

(54) Active modular optoelectronic components

(76) Inventors: Mark Margolin, Highland Park, IL (US); Gregory Bunin, Lake Zurich, IL (US)

Correspondence Address: PATZIK, FRANK & SAMOTNY LTD., 150 SOUTH WACKER DRIVE, SUITE 1500, CHICAGO, IL, 60606, US

(21) Appl. No.: 11/513,577

(22) Filed: Aug. 31, 2006

(51) Int. Cl. G02B 6/36

(52) U.S. Cl. 385/89; 385/88; 385/92

(57) ABSTRACT

Super miniature TFF and TFP active modular optoelectronic components are based on an optical interface that is substantially less than half the size of SFF/SFP components and more than five times smaller than an SC based component and provides a density that is three times higher than LC interfaces. The invention provides substantially smaller passive interconnect systems that can be used with substantially smaller photonic devices and combines the new photonic devices with the new smaller miniature interconnect systems such as the Push-Push Interconnect system. The new interface can be used with 0.8 mm or larger interfaces. Photonic devices are mounted directly on the active end of a ferrule thereby enabling use with coatings, avoiding the need for lenses, enabling use in active hermetic or non-hermetic subassemblies, and enabling use of optional posts to set the separation of the photonic device from the fiber.

### THE FIELD OF THE INVENTION

The invention relates to the field of communication along a fiber optic channel. More specifically, the invention relates to active fiber optic components or photonic devices such as transceivers, transmitters and receivers that can be used with sub-millimeter diameter interconnect systems.

### BACKGROUND OF THE INVENTION

Fiber optic transceiver modules, also known as optoelectronic transceivers, transmit optical signals and receive optical signals. Such transceivers provide for the bi-directional communication of signals between an electrical interface and an optical interface. A fiber optic transceiver includes a circuit board that contains at least a receiver circuit, a transmit circuit, a power connection and a ground connection.

Transceivers and other active fiber optic modules are miniaturized in order to increase the port density associated with the network connection with respect to switch boxes, cabling patch panels, wiring closets, computer I/O and the like. Form factors for miniaturized optical modules such as Small Form Factor Pluggable (“SFP”) that specifies an enclosure about 9.05 mm in height by about 13.2 mm in width and having a minimum of 20 electrical input/output connections. In order to maximize the available number of optical transceivers per area multiple SFP modules are arranged in rows and columns. Each SFP transceiver module or other active photonic module is plugged into a socket or receptacle.

Optical components include: light emitting and detecting devices (i.e. photonic devices such as lasers and photodiodes) and optical fibers. Photonic devices are electrically connected to semiconductor devices. The ends of optical fibers are positioned proximate to the active areas of the photonic devices. Semiconductor lasers are used as the light emitting devices and are referred to as a die.

As the need for optical bandwidth has increased, high speed optical transceivers have been developed to satisfy this need. The primary markets for this demand for increased bandwidth has been both the local area network (LAN) and the storage area network (SAN) markets. The predominant LAN standard is Ethernet, while the predominant SAN standard is Fibre Channel. Transceivers from speeds of 155 Mb/s up to 10 Gb/s have been introduced that meet these requirements and it is expected that even higher speeds will soon be required.

The initial transceivers were based on 1×9 modules that were soldered onto a host circuit board and utilized dual SC optical connectors, an example of which is shown in FIG. 1A. The need for reconfigurability led to the development of the first hot-pluggable transceivers, known as GBIC, having a footprint similar to the 1×9 module shown in FIG. 1A, that could be plugged into a powered circuit board in a router, switch, or other such piece of equipment (thus, the term “hot-pluggable.”)

Arrays of these modules could be placed on the edge of a circuit board such that the SC outputs were presented at the output of a switch or router. The dual SC port arrangement limited the minimum size of the ports that could be stacked together. The ferrule of the SC connector is 2.5 mm in diameter. The center-to-center spacing of the dual SC port is 12.7 mm, and the width of the dual SC port is 26 mm. The height is 9.4 mm, which just fits the board-to-board spacing of stacked circuit boards customarily found in PCs and other electronic gear.

Shortly thereafter, the need to increase the density of optical ports resulted in the introduction of both the Small Form Factor soldered (SFF) and Small Form Factor Pluggable (SFP) transceivers. The SFF and SFP transceivers reduced the size of the modules in half in the horizontal direction by replacing the optical interface with dual LC connectors, which are half the size of SC connectors, as shown in FIG. 1B. The ferrule of the LC connector is 1.25 mm in diameter. The center-to-center spacing of the dual LC port is 6.1 mm, and the width of the dual LC port is 13.2 mm. The height of the dual LC port is 9.0 mm.

The large success of fiber optic networks based on these described active fiber optic transceivers has increased the demand for even higher port density that can only be met by transceivers and other active components that are even smaller than those currently available. Until now, no known optical interface has been able to successfully address this need for transceivers of smaller size. The present invention solves that problem with its new set of transceivers, as shown in FIG. 1C, that are based on a new optical interface that is substantially less than half the size of the standard SFF/SFP form factor, as shown in FIGS. 2A and 2B.

To convert electronic data to optical data for transmission on a fiber optic cable, a transmitting optical subassembly (“TOSA”) is typically used. A driver integrated circuit converts electronic data to drive a laser diode or an LED in a TOSA to generate the optical signal or data.

To convert optical data to electronic data, a receiver optical subassembly (“ROSA”) is typically used. The ROSA typically includes a photo diode that, in conjunction with other circuitry converts the optical data to electronic data. To communicate through fiber optic cables, usually both a ROSA and a TOSA are needed. Combining both a TOSA and a ROSA into a single assembly along with electronic devices and circuits, results in a transceiver. Typical transceiver designs combining discrete TOSAs and ROSAs suffer from drawbacks such as increased size, increased cost, decreased yield and the like.

Accordingly, there is a need for: active fiber optic modules that can be used in fiber optic interconnect systems that are useable with ferrules having sub-millimeter diameters; hermetic and non-hermetic structures with respect to photonic devices; and directly attaching photonic devices to the face of the ferrule carrying the fiber.

### SUMMARY OF THE INVENTION

The present invention includes miniature optical transceivers, and other photonic modules such as transmitters and receivers for industrial applications. The industrial applications include: telecommunication; data communication; data storage; gigabit/sec speed Ethernet and Fibre Channel.

The three major technical challenges faced and overcome by the present invention in achieving the desirable miniaturization include: (1) providing substantially smaller passive interconnect systems that can be used with ferrules having sub-millimeter diameters, such as the push-push interconnect system of co-pending application Ser. No. 11/166,556 filed Jun. 24, 2005 and Ser. No. 11/155,360 filed Jun. 17, 2005; (2) developing the substantially smaller active fiber optic modules, which can transmit, receive or both, based on the ferrule pak of the present invention; and, (3) combining the new smallest known TOSAs and ROSAs with the new passive interconnect systems in very close proximity to the face of the ferrule and the fiber carried by the ferrule so as to enable formation of the highest density known optical transmitters, receivers, and transceivers. The alignment thereof can be done passively or actively. These three goals were achieved by way of the ferrule pak utilizing a subminiature ceramic ferrule with a 0.8 mm diameter. This ferrule pak forms the heart of the smallest known TOSAs and ROSAs and the resulting active fiber optic modules.

With the architecture of the present invention, the fiber can be placed in very close proximity with the active area of the photonic device, thereby avoiding the need for a lens interposed therebetween. Expensive active alignment can thus be avoided. Because there is a small gap between the fiber and the photonic device, a thin gel may be used in non-hermetic applications to protect the devices from damage caused by moisture.

The ferrule pak has two or more deposited metal contacts and pads on one end for connecting with photonic devices and can also have metalized areas for achieving hermeticity. Photonic devices such as a VCSEL or detector, can be mounted directly on the contacts in a flip-chip fashion.

Among the advantages of the present invention are its super miniature size which is approximately five times smaller than existing active fiber optic modules. The ferrule pak can be used with different coatings on the fiber area such as: anti-reflection; absorptive; mirror; filters; and the like. There is no need for lenses interposed between the photonic devices and the fiber area. The ferrule pak can be used in hermetic, non-hermetic or partially hermetic subassemblies. Optional posts can be interposed between the photonic device and the fiber area to set the distance of the photonic component from the fiber.

The present invention further includes photonic devices comprising a barrel active subassembly for either TOSA or ROSA applications. Such barrel active subassemblies are designed for use in non-hermetic applications.

With the present invention, there is sufficient accuracy provided such that flip-chip processes can be used to allow passive alignment of the fiber and active components, so as to avoid often complicated and expensive active alignment wherein the active components need to be powered and then moved relative to the fiber to achieve an optimum level of electrical output.

The present invention provides for versions comprising: non-hermetic, partially hermetic and fully hermetic barriers surrounding the delicate photonic devices depending on the specifications.

The present invention further provides the smallest known package for photonic devices in combination with a fiber optic interconnect system. Currently, the smallest known such package is a can measuring 3.6-3.8 mm in diameter. The new interface of the current invention with the 0.8 mm diameter ferrule has a three times higher density than a typical LC type connector (See, FIG. 1B for LC versus FIG. 2A for the current invention).

The fiber pak active subassemblies of the present invention can be either optical transmitters or optical detectors that are sized to be interchangeable and thereby provide modularity within their respective component housings. Hence the same active subassemblies can be interchanged with the subassemblies of other component housings as needed. Moreover, the active subassemblies can be provided in single or duplex forms. Hence, six transmitter modules, six receiver modules or a combination thereof can be provided in the same footprint as one SFP module.

Moreover, the active fiber optic modules of the present invention can be either hot pluggable or soldered to their respective PC boards. In addition, the smaller form factors of the present invention provide for higher densities of fiber optic components than is currently achieved.

These and other features of the present invention will become more fully apparent from the following description and appended claims, or may be learned by the practice of the invention as set forth hereinafter.

### BRIEF DESCRIPTION OF THE DRAWINGS

The appended drawings contain figures of various embodiments of the present invention. The features of the invention mentioned herein, as well as other features will be described in connection with the embodiments. However, the illustrated embodiments are only intended for illustrative purposes and not to limit the invention. The drawings contain the following figures:

FIG. 1A is a dimensioned side view of a prior art duplex SC transceiver.

FIG. 1B is a dimensioned side view of a prior art duplex LC transceiver.

FIG. 1C is a dimensioned side view of a duplex transceiver of the present invention.

FIG. 2A is a dimensioned side view of three stacked side-by-side duplex transceivers arrangement of the present invention.

FIG. 2B is a dimensioned side view of the three stacked side-by-side single channel active adapter of the present invention.

The smaller form factor optical modules of the present invention are designated as the Tiny Form Factor soldered (TFF) and Tiny Form Factor Pluggable (TFP). FIG. 2C is a side dimensioned view of the smallest of the TFF/TFP modules comprising three stacked side-by-side single transmitters or receivers based on a simplified active adapter of the present invention.

FIG. 3 shows an example of three simplified soldered devices stacked together in triple or three-across fashion.

FIG. 3A shows single simplified module before soldering to the PC board.

Duplex active adapter with push-push mechanism and internal shutter is shown in FIG. 4 and its exploded view is shown in FIG. 4A.

Single channel active adapter with push-push mechanism and internal shutter is shown in FIG. 5 and its exploded view is shown in FIG. 5A.

The simplified active adapter (hot pluggable version) is shown in FIG. 6 and its exploded view is shown in FIG. 6A.

The exploded view of the simplified active adapter (soldered version) is shown in FIG. 6B.

FIG. 7 is a perspective view of the basic ferrule pak.

FIG. 7A is an exploded view of the ferrule pak.

FIG. 8 is a perspective view of the barrel active subassembly.

FIG. 8A is an exploded view of the barrel active subassembly.

FIG. 9 is a perspective view of an active ferrule subassembly that is non-hermetic.

FIG. 9A is an exploded view of FIG. 9.

FIG. 10 is a perspective view of the hermetic active subassembly.

FIG. 10A is an exploded view of FIG. 10.

FIG. 10B is an exploded view of FIG. 10 from the opposite angle as FIG. 10A.

FIG. 11 is a perspective view of the active subassembly with active alignment of the photonic device and the ferrule assembly.

FIG. 11A is an exploded view of FIG. 11.

FIG. 11B is an exploded view of FIG. 11 from the opposite angle as FIG. 11A.

FIG. 12 is a partially exploded view of the miniature adapter including both push-push mechanisms and both shutters.

FIG. 13 shows an overall perspective view of the miniature connector partially inserted into the miniature adapter (the adapter shell 702 of FIG. 12 is removed).

FIG. 14 is an overall perspective view of the miniature adapter with locking spacer 740 prior to engagement with the connector.

FIG. 15 is a top view of the miniature adapter and miniature connector when connector 707 is partially inserted into adapter 701 and the adapter shell 702 of FIG. 12 is removed.

FIG. 16A is an isometric view and FIG. 16B is a bottom view of flipper 715 (see FIG. 12, FIG. 14 and FIG. 15).

FIG. 17 (from A to F) is a schematic view which shows different positions of flipper 715 of the adapter and dual pin 712 (See, FIGS. 13-16) of the connector during the push-push insertion and withdrawal action.

### DETAILED DESCRIPTION OF THE DRAWINGS

Reference will now be made to other aspects of the drawings, to describe the invention. It is to be understood that the drawings are diagrammatic and schematic representations of certain embodiments and are not limiting of the present invention, nor are they necessarily drawn to scale.

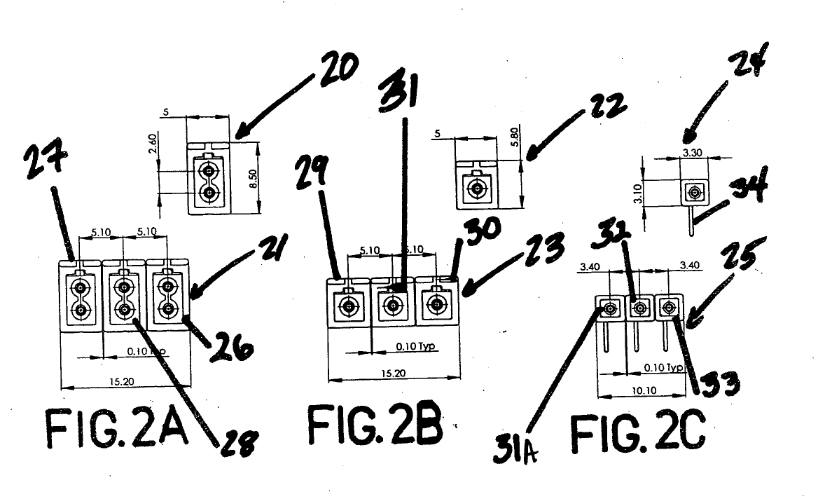

Duplex unit 21 comprises modules 26, 27 and 28 of FIG. 2A arranged in a triplet or three-across configuration. Modules 26, 27, 28 can be transceivers, transmitters or detectors depending upon the active components contained in each. For example, if module 26 contains both a transmitter and a detector as its two active components, then it would be a transceiver.

The footprint of a module is defined as the height versus the width of the module. Also shown in FIG. 2A is single duplex module 20 having a footprint of only 5.0 mm wide by 8.5 mm high. The ferrule center to center vertical distance of duplex module 20 is only 2.6 mm. As shown in FIG. 2A the total width of triplet duplex module 21 is only 15.2 mm. The horizontal measured center to center of each ferrule of module 26, 27, 28 of unit 21 is only 5.10 mm. The duplex modules of FIG. 2A each contain two active components and yet are only 8.5 mm high.

Single transmitter or detector versions of unit 23 are shown in FIG. 2B in triplet or three-across arrangement as module 29, 30, 31. Center to center the ferrules of unit 23 are 5.10 mm apart in the horizontal direction. Overall, the three modules of unit 23 are only 15.20 mm wide. Single module 22 is shown in FIG. 2B having a width of 5.0 mm and a height of 5.80 mm.

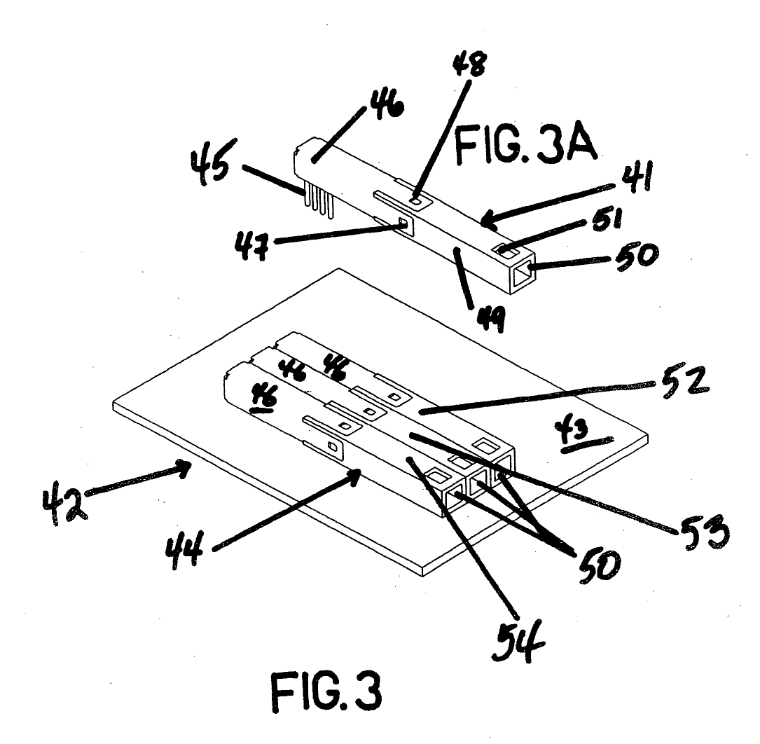

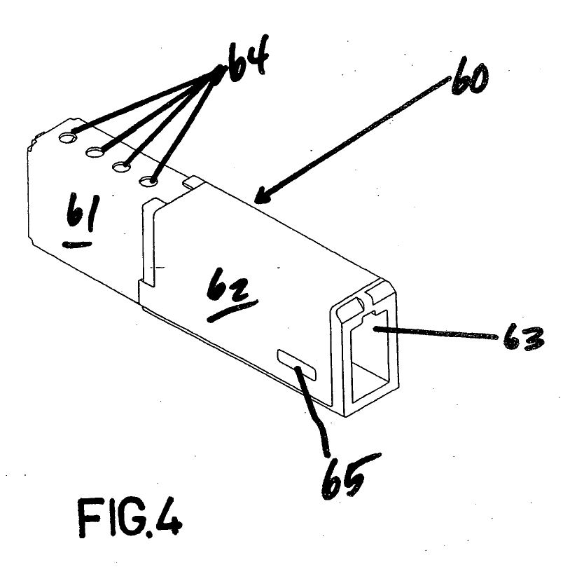

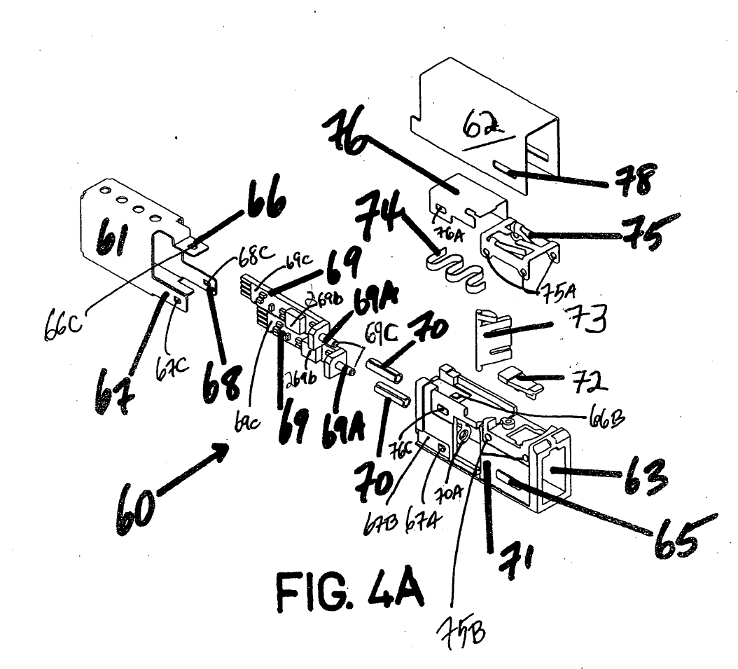

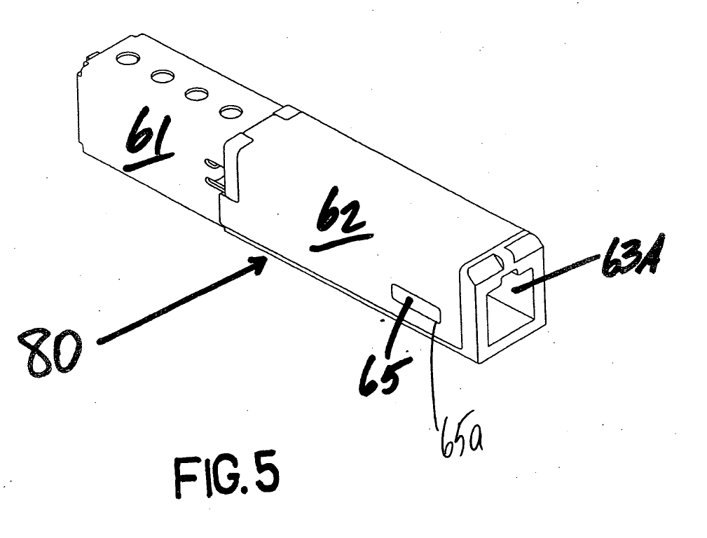

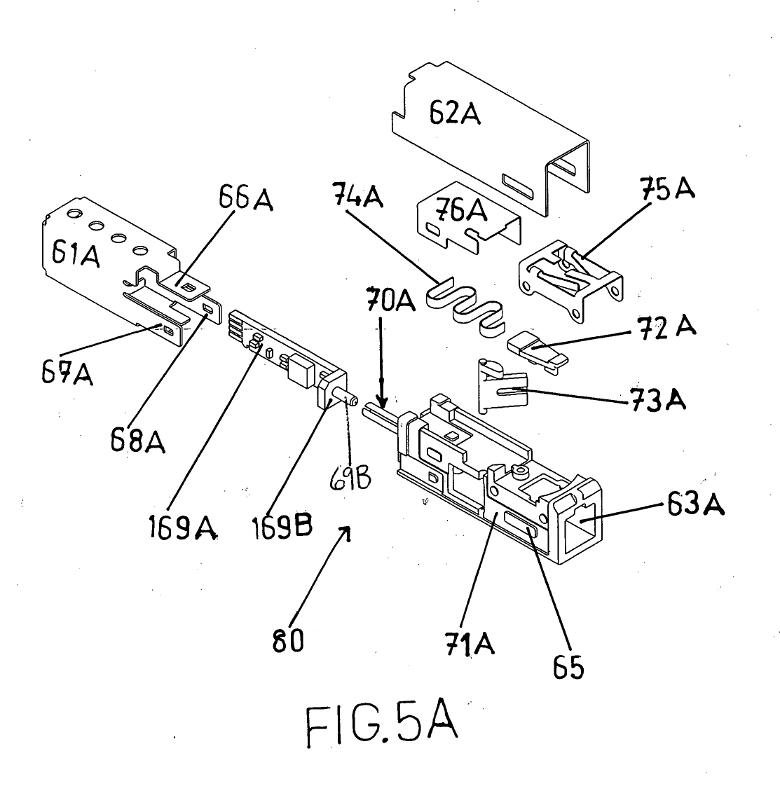

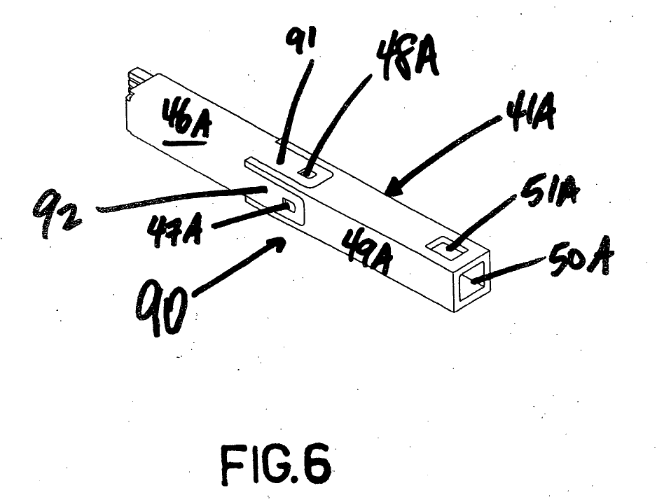

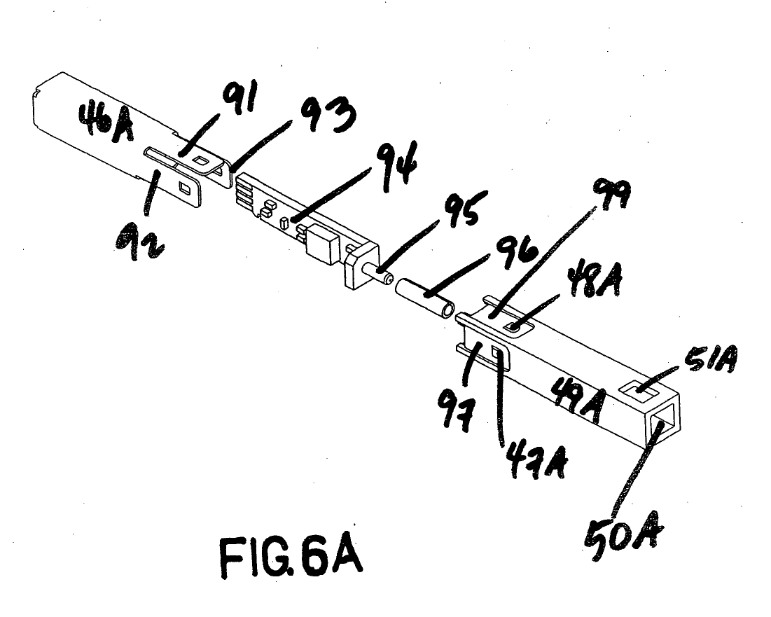

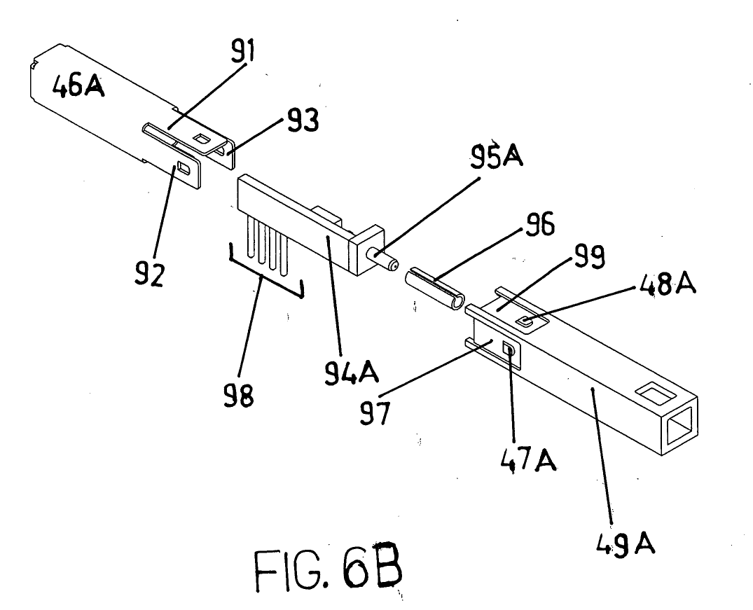

In addition, the present invention includes transmitters and receivers that do not need a full connector body, thereby reducing the size even further as shown in FIG. 2C. The total width of the triplet module arrangement of unit 25 comprising modules 31A, 32, 33 is 10.10 mm. The ferrule center to center horizontal width of unit 25 is only 3.4 mm. Single module unit 24 of FIG. 2C is 3.10 mm high and 3.3 mm wide and has pins 34 for conductive attachment by soldering or the like to a printed circuit board. This modification can be used inside of the chassis for on-board connections as shown in FIG. 3.

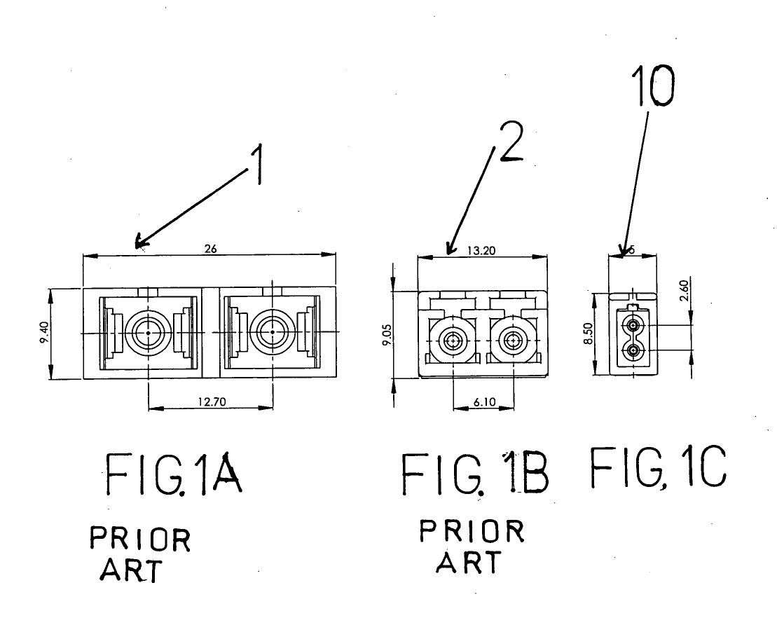

The smaller form factor optical modules of the present invention are designated as TFF (soldered) and TFP (pluggable). The ferrule diameter for all versions of the present invention can be as small as 0.8 mm. The center-to-center ferrule spacing is as follows:
2.6 mm for the duplex transmitters, as shown in FIG. 1C;
3.4 mm for the stacked simplified soldered version as shown in FIG. 2C;
5.1 mm for the stacked single channel version as shown in FIG. 2B; and,
5.1 mm for the stacked duplex version as shown in FIG. 2A.

The respective heights of the: duplex modules are 8.5 mm (see, FIG. 2A); simplified transmitter or receiver module is 3.1 mm (see, FIG. 2C); single channel transmitter or receiver module is 5.8 mm (see, FIG. 2B). Further, horizontal port density can be increased even further by rotating the dual port module by 90 degrees (with respect to FIGS. 1C and 2A) so that the dual modules can be stacked in the vertical position. In that vertically stacked configuration horizontal port spacing is 5.1 mm. Moreover, three transceivers can be configured in one body (not shown) so that the overall width is 13.2 mm which is exactly the width of the SFF/SFP (see, FIG. 1B). That enables use of six channels of TFP or TFF versus two channels of SFP or SFF, respectively in the same footprint.

The smallest of the TFF/TFP modules is a single transmitter or receiver based on a simplified adapter and is shown in FIG. 2C. Individual transmitters and/or receivers can be stacked on the PC board in any desired combination. FIG. 3 shows an example of three devices 44 stacked together and soldered to the PC board 43. Pins 45 enable attachment to the PC board 43 in the known manners. Single device module 41 is also shown in FIG. 3A prior to attachment to the PC board. Devices 41 and 44 are shown as having EMI shields 46 attached to simplified adapter housings 49 and 52, 53, 54 respectively. Using device 41 as an example, latches serve to connect the shield to simplified adapter housing 49 by way of raised tabs 47 and 48. Opening 50 is adapted for receiving a contact carrying a ferrule (not shown). Top opening 51 is adapted to receive and retain a latch of a contact (not shown) to couple and maintain the adapter and contact in coupled relation.

A more robust, somewhat larger configuration is based on a single channel active adapter as shown in FIG. 2B and FIGS. 4 and 4A. Individual TFF/TFP transmitters and receivers would utilize this form factor. Duplex active adapter 60 with an internal push-push mechanism and an internal shutter of the type described herein (as well as in co-pending U.S. patent application Ser. No. 11/166,556 filed Jun. 24, 2005 and Ser. No. 11/155,360 filed Jun. 17, 2005 and herein incorporated by reference (hereinafter referred to as the “Push-Push connector/adapter mechanism”) is shown on FIG. 4. The Push-Push mechanism is controlled by the connector's internal spring and works automatically when miniature connectors are connected or disconnected to or from the interior of the adapter. In this version of the Push-Push connector, pushing a first time on the connector connects the connector to the adapter. Pushing on the connector a second time, serves to disconnect the connector from the adapter.

Optional dust and laser protection shutters 73 are included in both modular connectors and adapters. These shutters 73 are controlled by a spring mechanism 74, and open and close automatically when modular connectors and adapters are attached or separated. A push-push mechanism is also included that keeps the connection securely together or actively uncouples the modular connector and adapter. This facilitates the handling of the very small connector plugs. EMI (electromagnetic interference) protection is included in both the modular connector and adapter by way of metallic shields 61 and 61A.

An adapter shutter mechanism in the modular connector version of the invention comprises an S-shaped spring 74 acting upon the cams of shutter doors 73 mounted to rotate about a vertical axis at the open end 63 of the active adapter. Other types of springs and means for biasing the shutter doors into a normally closed position, such as spring clips, coil springs, torsion springs, elastic materials, etc. should be considered as being within the scope of this invention. When the adapter does not have a modular connector inserted in an open end, the S-spring 74 pushes against the cam of the shutter door 73 at the open end 63 so as to urge it into the closed position. Front of the connector pushes against the adapter door 73 and overcomes the force of the S-spring 74 on the adapter door so as to automatically move it into the open position. A mechanism to keep connector and adapter together is a Push-Push mechanism.

There are two versions of the active component subassembly of the present invention: either soldering to the PC board or hot pluggable. It employs an automatic shutter for eye safety and dust protection. It enables the use of active component subassemblies 69, 169A, 94, and 94a as described in connection with FIGS. 4A, 5A, 6A, and 6B, respectively. This enables use of universal PC boards with different types of active photonic devices thereon. Adapter 60 of FIG. 4 includes metallic EMI shield 61, series of holes 64, cover 62, retention tab 65 and front opening 63 for receipt of a connector carrying a ferrule (not shown). The exploded view of adapter 60 is shown in FIG. 4A.

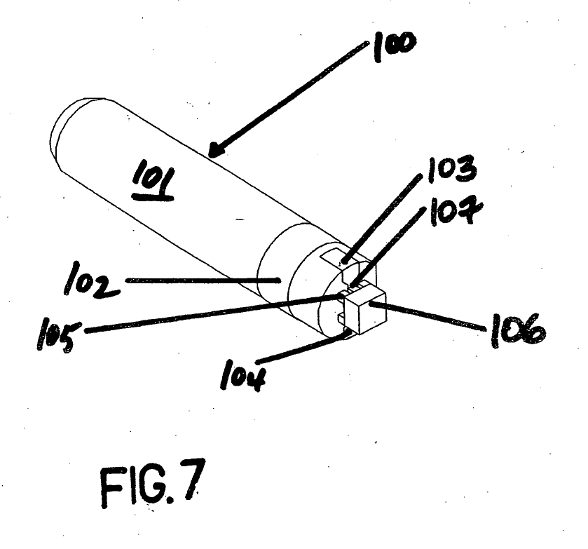

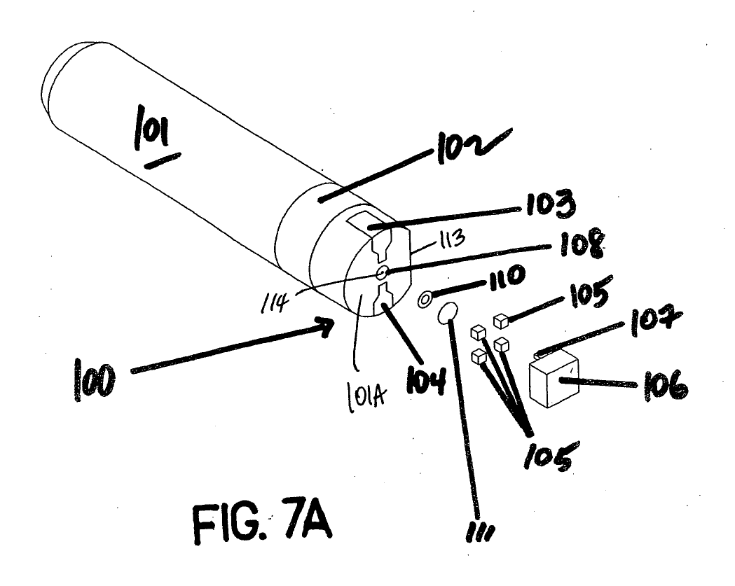

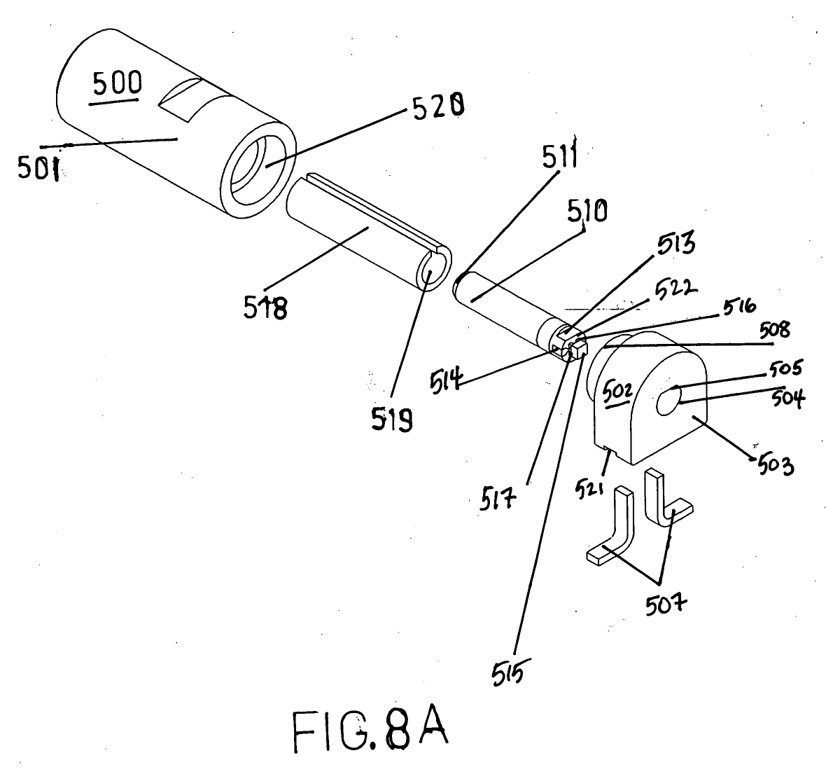

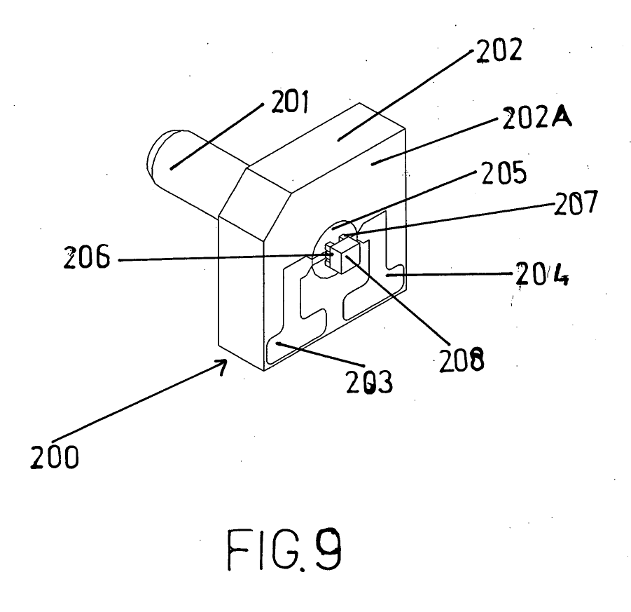

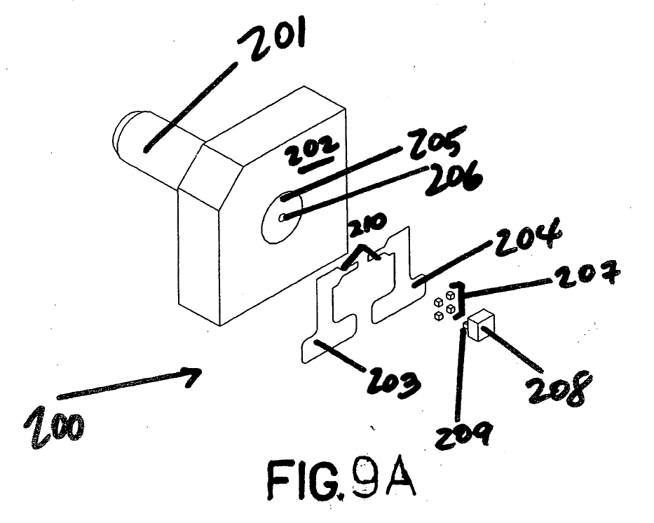

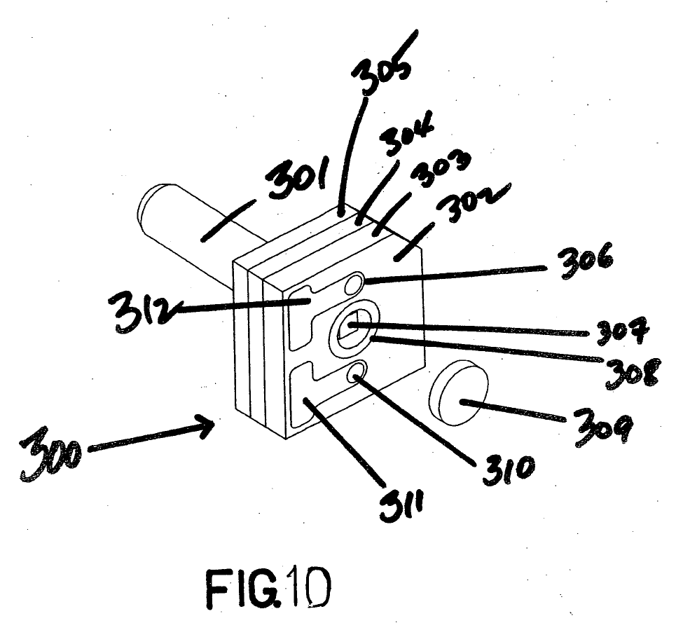

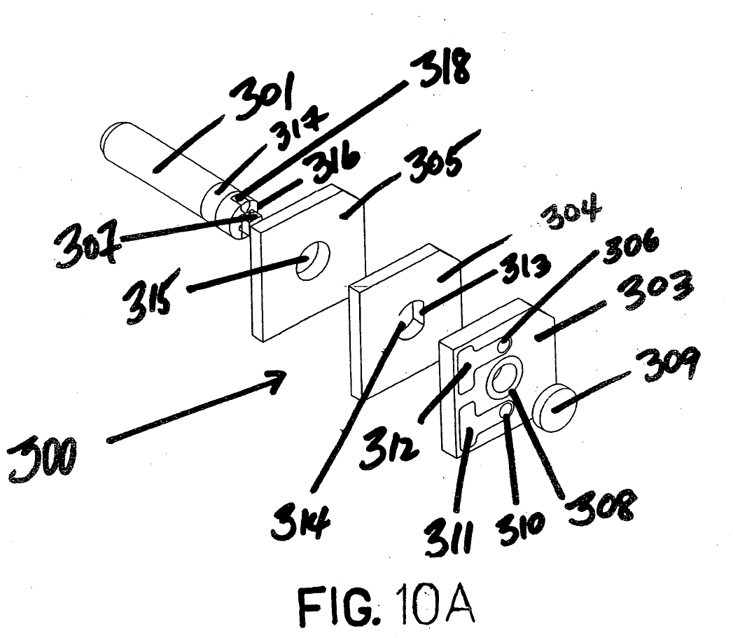

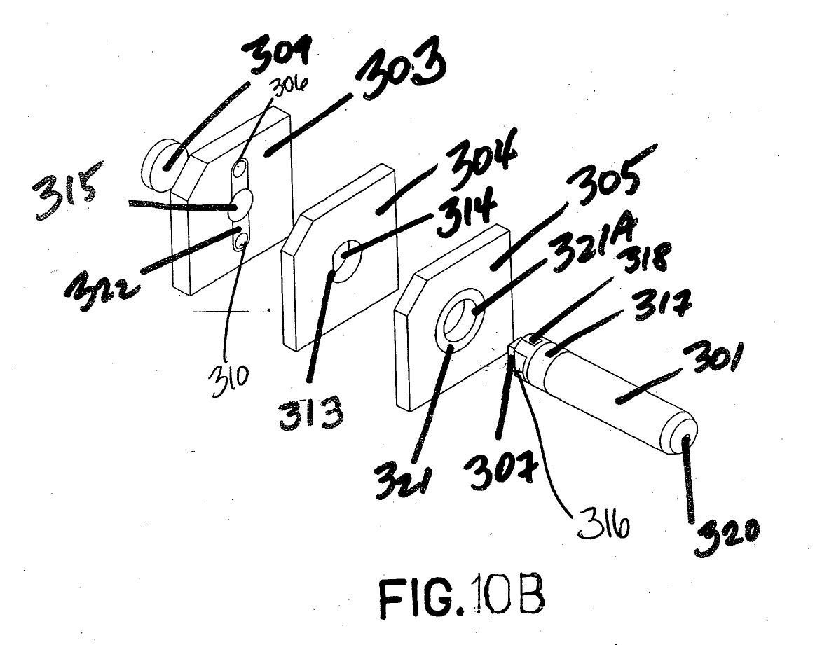

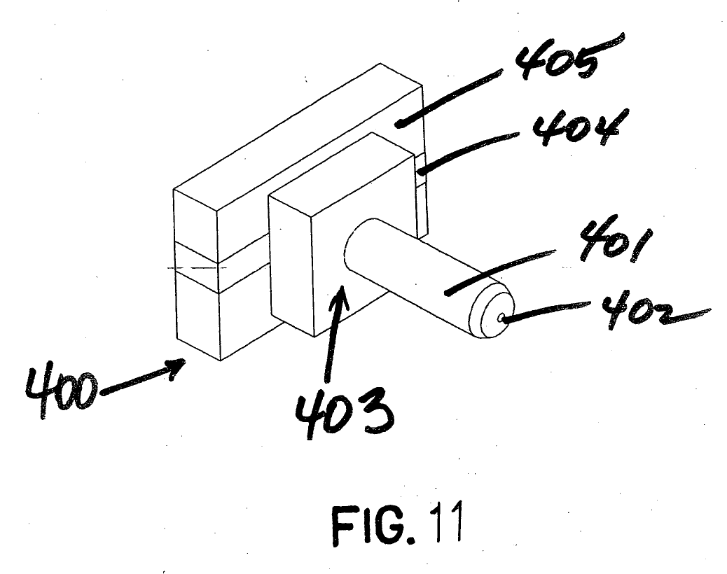

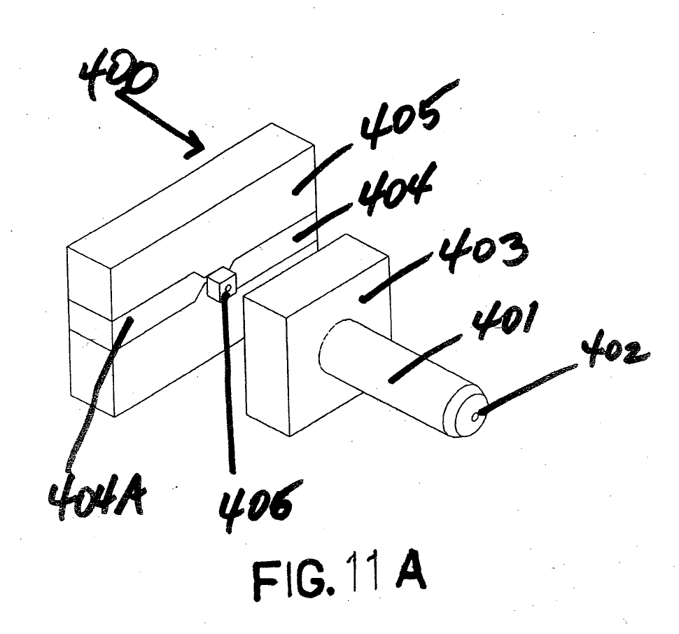

With reference to FIG. 4A, shield 61 has prongs 66, 67, 68 for latched receipt by internal adapter body 71. In particular, holes 66c, 67c, 68c engage tabs 66b, 67a and 68a (not shown) on internal body 71 when coupled together, so as to latch shield 61 to body 71. Interposed in this embodiment, between shield 61 and internal body 71 are two active components comprising optoelectronic assemblies 69 each having one photonic component 69a operatively attached to PC boards 69c. Alternatively, 69 can be a single PC board 69C with two photonic components 69c attached to it. The active components of active subassembly 69 can be both: transmitters such as VCSELs or other Lasers; receivers such as detectors or a combination of each, so as to form a transceiver. Photonic components 69a include ferrule paks of the type described in connection with ferrule pak 100 of FIGS. 7 and 7A and the active photonic subassembly 200 of FIGS. 9 and 9A. Additionally, photonic components 69a can comprise active photonic subassemblies of the type described in connection with FIGS. 10, 10A and 10B or FIGS. 11, 11A and 11B.

In FIG. 4A, ferrules 69C of photonic components 69a are received by alignment sleeves 70 and, in turn, barrels 70a (only one of which is visible in FIG. 4A) formed within internal body 71. Cover 62 has slots 78. Interposed between cover 62 and internal body 71 are: cover 76 with slot 76a which fits over push-push spring 75; spring 74; shutter 73; and flipper 72 so as to provide a Push-Push mechanism for coupling and uncoupling adapter 60 from a connector (not shown) by applying a first force to couple adapter and connector and to apply a second force in substantially the same direction and at substantially the same location to uncouple the adapter and connector. Latching of the various components is achieved by engagement of holes: 76a with tabs 76c; 75a with tabs 75b; and, 78 with tabs 65. Other known methods of coupling should be considered as being within the scope of the invention. This Push-Push mechanism, due to its unidirectional coupling and uncoupling forces, enables use of super miniature connectors and active devices in very high density environments.

The single channel active adapter embodiment 80 of the present invention with a Push-Push mechanism and internal shutter is shown in FIG. 5 and its exploded view is shown as FIG. 5A. It can require soldering to the PC board or be hot pluggable. It employs an optional automatic shutter for eye safety and dust protection. It also includes a push-push type coupling mechanism. It enables the use of active component subassemblies 169a of FIG. 5A, 69, 94, and 94a as described in connection with FIGS. 4A, 6A, and 6B, respectively. This enables use of universal PC boards with different types of active photonic devices thereon. Adapter 80 includes: shield 61 and adapter cover 62 which traps tab 65 in opening 65a; as well as opening 63a for receipt of a connector carrying a ferrule (not shown). As previously explained in connection with adapter 60 (See, FIG. 4A), shield 61a (See, FIG. 5A) has prongs 66a, 67a, and 68a for the capture of corresponding tabs on internal housing 71a.

With reference to FIG. 5A, interposed between shield 61a and internal housing 71a in adapter 80 is the active photonic subassembly 169a comprising a PC Board and ferrule pak 169b. Active subassembly 169a can be a transmitter assembly or receiver assembly. Ferrule 69b is received by alignment sleeve 70a, which is received by a barrel (not shown) within the housing 71a. As explained with respect to FIG. 4A, cover 62a fits over cover 76a, push-push spring 75a, spring 74a, flipper 72a as well as internal shutter 73a which cooperates with housing 71a to provide a Push-Push mechanism that enables coupling and uncoupling of adapter 80 with a connector (not shown) inserted or retracted from opening 63a by application of a coupling force or an uncoupling force in the same direction and at the same location.

Photonic component subassembly 200 of FIG. 9, includes a ferrule subassembly 169a including ferrule pak 69b of the type described in connection with ferrule pak 100 of FIGS. 7 and 7A and the active photonic subassembly 200 of FIGS. 9 and 9A. However, the photonic components of subassembly 169a (not shown in FIG. 5A) can comprise active photonic subassemblies of the type described in connection with FIGS. 10, 10A and 10B or FIGS. 11, 11A and 11B as well.

The simplified active adapter (hot pluggable version) embodiment 90 of the present invention is shown on FIG. 6 and its exploded view is shown in FIGS. 6A and 6B. This simplified active adapter can be provided in either a pluggable (see, FIG. 6A) or soldered version (see, FIG. 6B). It can be assembled as a transmitter or as a receiver, depending upon which active photonic subassembly is used. It can further be mounted in a horizontally stackable configuration as shown in FIG. 3.

With respect to FIGS. 6 and 6A, shield 46a has prongs 91, 92 for receiving tabs 48a, 47a respectively of simplified adapter housing portion 49a when engaged. Opening 50a is adapted to receive a modular contact (not shown) carrying a ferrule. Opening 51a captures a latch on the contact for engagement purposes.

As shown in FIG. 6A, EMI shield 46a has prongs 91, 92, 93 and simplified adapter housing 49A with active assembly 94 interposed therebetween. Ferrule 95 is received within alignment sleeve 96. Holes in prongs 91, 92, 93 slip into indented regions 97, 98 (not shown), 99 and capture tabs 47a, 48a and 49a (not shown) of simplified adapter housing 49a. The active subassembly 94a is shown in FIG. 6B in a reversed orientation with respect to that of FIG. 6A. Pins 98 are soldered or otherwise attached to the circuit board (not shown).

The photonic components of subassembly 94 and 94a of FIGS. 6A and 6B include ferrule paks of the type described in connection with ferrule pak 100 of FIGS. 7 and 7A and the active photonic subassembly 200 of FIGS. 9 and 9A including the ferrule pak. Additionally, photonic components 94 and 94a can comprise active photonic subassemblies of the type described in connection with FIGS. 10, 10A and 10B or FIGS. 11, 11A and 11B as well.

As shown in FIG. 6B, shield 46a slips over active assembly 94a. Ferrule 95a is slipped into sleeve 96 and prongs 91, 92, 93 slip into indented regions 99, 97 of simplified adapter body 49a so as to capture tabs 48a, 47a and 49a (not shown) therein and operably align active assembly 94a therebetween.

In the invention described herein, a plurality of contacts is formed on the surface of a ferrule containing single- or multi-mode fiber (“SM” or “MM” fiber, respectively). These contacts are patterned to engage corresponding features in a photonic device or devices, including but not limited to lasers, photodiodes, and integrated circuits. The contact features may be deposited and patterned using a variety of methods. In one embodiment, physical vapor deposition is utilized to form a multilayer metallic stack, and the pattern is created through the use of a shadow mask. The multilayer metallic stack is optimized for adhesion to the material comprising the ferrule and for photonic die attach purposes. Examples of the material for such deposited metal contacts include but are not limited to titanium-platinum-gold and chromium-gold.

Alignment and mounting of the photonic devices may also be accomplished using a variety of techniques. In one embodiment, devices are passively attached using a flip-chip bonder where the core or cladding of the fiber along with features on the photonic device are imaged for alignment purposes, and the attachment is effectuated through the use of an epoxy or eutectic material.

Active alignment wherein one component is moved with respect to the other until the optimal position is found may also be utilized. Other coatings may be applied to the ferrule prior to device attach, such as anti-reflective coatings, absorptive coatings, mirrors or reflective coatings. In the case of reflective coatings, the deposited material may perform a function in conjunction with the mounted device, such as forming a laser cavity for a surface emitting laser.

The durability of optoelectronic devices is typically limited by the photonic devices, which tend to be delicate devices that are adversely affected by elements such as dust, moisture, PCB mounting flux residue, cleaning residue and physical handling. Hence, depending on the application photonic devices can be either: hermetically sealed; quasi-hermetically sealed; or, non-hermetically sealed. Impermeable materials like ceramics, glass and metals as well as special epoxies are used to hermetically seal a photonic device. Plastics or FR4 are permeable materials used only when protecting the photonic device when moisture protection is not important. Other materials used for non-hermetic sealing include those that allow for seepage of moisture over time, such as polymers and regular epoxy adhesives.

In FIGS. 7 and 7A the basic ferrule pak 100 embodiment is shown. The ferrule pak 100 includes a ferrule body 101, usually made of a ceramic material, within which is a precision bore hole through which a single mode (“SM”) or multi-mode (“MM”) fiber 108 (not shown in FIG. 7) can be inserted and epoxied in place. Polished ends 101a can be used for interfacing with an optical patch cord on one end (not shown in FIG. 7A) and as a substrate for attachment die 106 on the other. Fiber core 114 is surrounded by fiber 108. Metallic contacts 103 and 104 are provided so that a die such as active photonic component 106 can be mounted and operated. Active photonic device 106 can be a laser or a detector. Contacts 103, 104 each have flip-chip pads at their ends closest to fiber 108 to make contact with active photonic element 106. While two contacts 103, 104 are shown, more may be used, depending upon the application.

A multiplicity of other features can also be added to increase functionality or improve performance of the ferrule pak 100. These features are also shown on FIGS. 10A and 10B. The first category of features, shown in FIGS. 7 and 7A, is used for allowing the ferrule pak 100 to be employed in hermetic applications. An optional metal ring 102 may be deposited around the diameter of ferrule body for soldering purposes (317 in FIGS. 10A and 10B). With reference to FIG. 7A, a second optional metal ring 110 may be deposited or otherwise placed over the epoxy portion 108 on the polished face 101a (die attach side) which, in conjunction with metal ring 102 and a joining technique such as soldering or welding, forms a seal that serves as one end of a hermetic barrier.

Other features relative to polished face 101a may include optional posts or spacers 105 (to set the gap or distance of the optical component 106 away from the fiber core 114), an optical coating 111 such as an anti-reflective coating, absorptive coating, mirror, optical filter, etc., and an alignment flat 113. A mirror could be used as a coating 111. A gel could also be used on the polished face 101a.

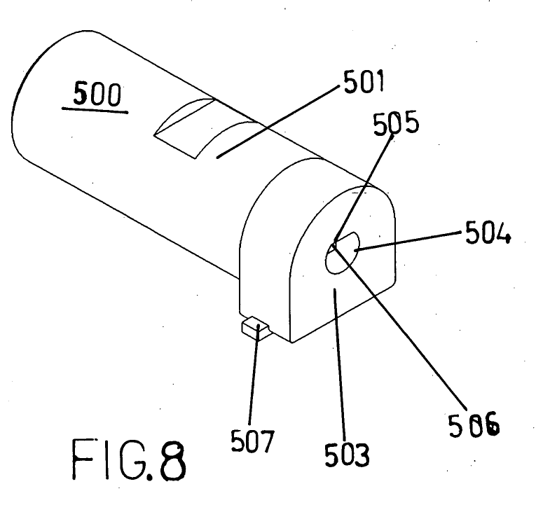

FIGS. 8 and 8A depict the embodiment of the present invention comprising the barrel active subassembly for use as a TOSA/ROSA photonic device. This photonic device is designed for use in non-hermetic applications. The ferrule of this active component can be assembled with SM or MM fiber and can be APC polished, as needed. It employs a modular universal design and can be used in different configurations and with any of the entire family of active devices, including: transceivers; transmitters; or receivers. It is designed to be mounted on a PC board (not shown) by a surface mount method (as in the example shown in FIGS. 8 and 8A or by soldering the leads thereof through vias on the circuit board. It is intended primarily for large volume automation.

As shown in FIG. 8, barrel active subassembly 500 includes barrel 501 assembled with end cap 503 with central bore 504 with flat wall 505 and interior containing the photonic device, not shown. Leads 507 are used in this example to mount subassembly 501 to the PC board (not shown). The exploded view FIG. 8A shows ferrule pak 510 having active end 522 and passive end 511. Ferrule flat 513 cooperates with flat region 505 of end cap 503 for proper alignment. Photonic device 515 is operably connected to contacts 514 and 516 deposited or otherwise placed in close proximity to active end 522 of ferrule pak 510 with optional spacers 517 interposed for correct spacing. Leads 507 are connected at one end to recesses 521 in sides 502 of end cap 503 and also to contacts 514 and 516 and at the other end, in this example, surface mounted to the PC board, not shown.

Referring to FIG. 8A passive end 511 of ferrule pak 510 is received and held by first end 519 of alignment sleeve 518 in aligned relation. Barrel 501 has first female end 520 for receipt of sleeve 518 holding ferrule pak 510. Indexed central bore 504 of end cap 503 receives active end 522 of ferrule pak 510 in correct orientation due to corresponding flat 513 of ferrule pak 510. Male portion 508 of end cap 503 is received by correspondingly shaped female portion 520 of barrel 501. Photonic device 515 is thus housed within end cap 503 in a non-hermetic manner in this example.

In FIGS. 9 and 9A another embodiment of an active photonic subassembly 200 including the ferrule pak 201 is shown, wherein the ferrule pak 201 is inserted or press-fit through a via or passage formed in plate 202, which can be made of ceramic or standard PC board materials such as FR4. Ferrule pak 201 in this example, is of the type described in connection with FIGS. 7 and 7A herein. It can be assembled with SM or MM fiber and may be APC polished if needed.

The active subassembly 200 is designed for non-hermetic applications. The epoxy around fiber 206 of FIG. 9A does not prevent moisture from getting to photonic device 208. Accordingly, the configuration of embodiment 200 does not preserve hermeticity of the photonic device 208.

Ceramic ferrule 201 is press-fit or epoxied into plate 202. The overall assembly is polished on both sides, and metal contacts 203, 204 are deposited for photonic devices 208 and other components, in a known manner. The resultant increased surface area of the overall assembly 202a (see FIG. 9) relative to the surface 205 of basic ferrule pak 201 allows both a greater number and larger components to be placed on the ferrule pak component surface 205. Pads 210 of contacts 203, 204 provide contact areas for contacts 209 of photonic devices 208. Non-hermetic active subassembly 200 serves as a more economical embodiment of the present invention since it uses a single layer ceramic plate or PCB material 202 instead of a multi-piece ceramic plate type structure.

In FIG. 10, a hermetic active subassembly embodiment 300 using the basic ferrule pak 301 with fiber core 320 (See, FIG. 10B) in conjunction with a multi-layer ceramic PC plate 303, 304, 305 is shown for the realization of a hermetic package. Ferrule pak 301 in this example, is of the type described in connection with FIGS. 7 and 7A herein. It can be assembled with SM or MM fiber and may be APC polished if needed.

As shown in FIG. 10A, ferrule subassembly includes ferrule pak 301 with fiber inserted and epoxied within its bore longitudinally and polished on both ends (not shown). Metal ring 317 is then deposited by the known method on ferrule 301. Alternatively one side of the ferrule could be polished, the ferrule press fit into the multi-layer PC board 303, 304, 305 and then polished together. The ferrule 301 can also be surface polished for good deposition of metal.

An exploded view of this hermetic active subassembly embodiment 300 is depicted in FIGS. 10A and 10B. In this device, the metal contacts 318 on the Ferrule Pak 301 are connected to an internal layer in the multilayer ceramic plate 303, 304, 305. The first ceramic plate 305 has a deposited metal ring 321 on the periphery of its central bore 321A to match the metal ring 317 on ferrule 301 when ferrule subassembly 300 is assembled.

Contacts 318 can be routed to vias 306, 310 with conductors that bring the signals to the top 303 plate of the board, where other active and passive electrical components 307 can be mounted. A hermetic seal can be achieved by soldering, sintering or otherwise attaching (in a secure and moisture and dust sealed fashion), ring 321 on plate 305 to the metal ring 317 on the ferrule body 301 and by similarly soldering, sintering or otherwise moisture sealing a hermetic lid 309 on the central ring 308 of plate 303.

Flat 316 on ferrule pak 301 and flat 313 or key on middle plate 304 must be correctly aligned so as to provide correct orientation of the ferrule and thereby avoid problems with polarity. Metal ring 321 is provided on front ceramic plate 305 to enable soldering of ferrule ring 317 to plate ring 321 to provide a hermetic barrier with respect to photonic component 307. When assembled the hermetic barrier below photonic component 307 is achieved by soldering rings 317 and 321; and from above photonic instrument 307 by soldering (or otherwise attaching in a hermetic way) of ring 308 in plate 303 to cap 309. Hermetic active subassembly 300 can be used in a variety of different types of active devices such as: transceivers, transmitters or receivers. While shown having an interface for an optical patch cord on the end not used for die attachment, the Ferrule Pak 301 may also be part of a larger optical subassembly, where the attachment of the die to the polished face of the ferrule is done for convenience.

Embodiment 400 is shown in FIGS. 11, 11A and 11B and comprises an active assembly with active alignment of the photonic device 406 mounted on contacts 404, 404a of ceramic plate 405 and ferrule subassembly 403. Ferrule subassembly 403 includes ferrule pak 401 which in this example, is of the type described in connection with FIGS. 7 and 7A herein. It can be assembled with SM or MM fiber and may be APC polished if needed.

Photonic device 406 can be a laser or a detector. Metal contacts 404 and 404a are deposited on to ceramic plate 405 in the previously described, known manner. Active alignment of photonic device 406 relative to ferrule subassembly 403 is achieved by moving plate 405 or ferrule subassembly 403 towards the other and then vertically or horizontally relative to the other, until an optimum reading is achieved on the instrument measuring either the light signal transmitted or received through ferrule 401 containing fiber 402, depending upon whether photonic device 406 is a laser or detector, respectively.

As further shown in FIG. 11B, in embodiment 400, ceramic plate 405 has photonic device 406 (not shown) mounted to contacts 404, 404a on the side facing the back of ferrule subassembly 403. A central bore 407 is formed inside of ceramic plate of ferrule subassembly 403. Proximal ferrule end 402a is recessed from back end of ferrule subassembly 403, so as to create a cavity capable of receiving photonic device 406. As shown, no lens is needed between photonic device 406 and ferrule end 402a containing a fiber.

Active alignment is achieved by manually or automatically moving ceramic board 405 vertically (in the V direction) or horizontally (in the H direction) as viewed in FIG. 11B until the optimum signal strength is achieved through or from ferrule 401 depending upon whether photonic component 406 is a laser or a detector, respectively. Once the maximum signal is achieved by way of such active alignment, plate 405 and ferrule subassembly 403 are affixed in any suitable, known manner.

While all of the examples of the invention described herein use a ferrule diameter that is less than one millimeter, the invention likewise includes application of the principles thereof to ferrule diameters over one millimeter. Among other things, the present invention has the advantage of avoiding the need to use cans to contain the photonic devices.

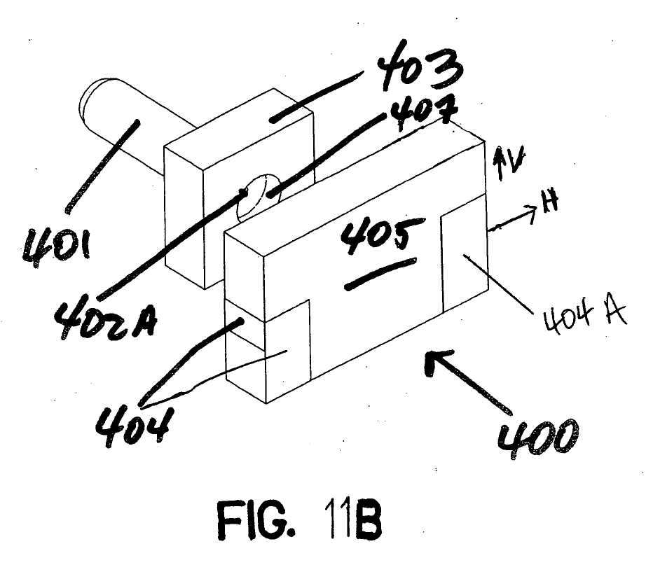

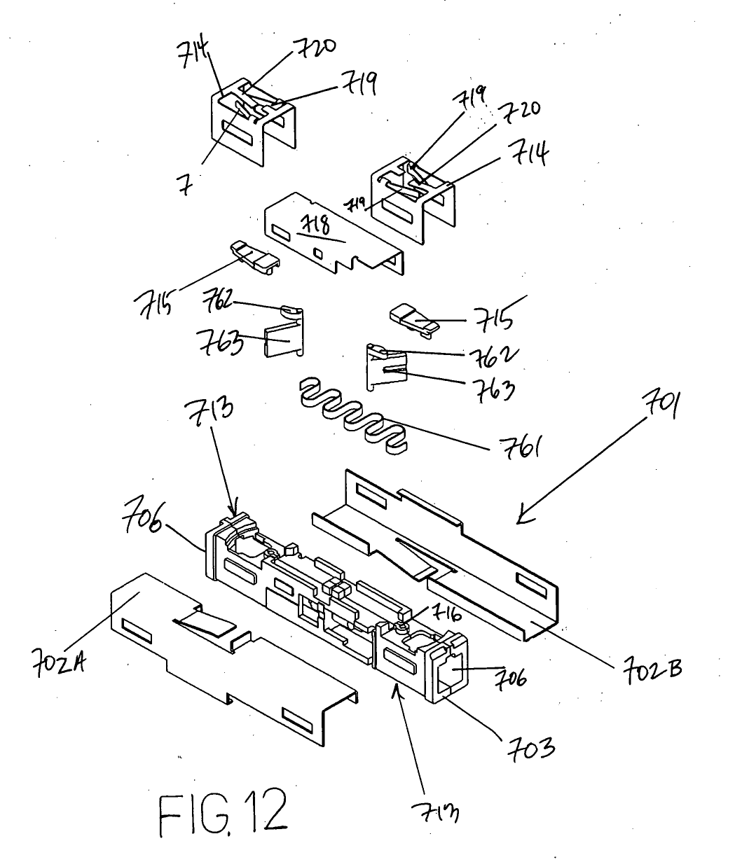

FIG. 12 shows a partially exploded view of miniature push-push adapter 701. In this view, two push-push type mechanisms 713 are shown near each of the apertures 706. Each mechanism 713 consists of push-push spring clip 714, flipper 715, and nest 716 which serves as a vertical axis about which the flipper 715 rotates or pivots. Also shown in FIG. 12 are dual shutter mechanism 717 and its cover 718. FIG. 12 further shows adapter 701 in partially exploded view. It also shows the S-shaped spring 761 which outwardly biases two cams 762, each of which is respectively attached to ends of vertically mounted internal shutters 763. Shutters in this example each have a vertical axis of rotation. When connectors are not inserted into the receiving apertures 706 of the adapter 701, spring-biased cams (See, 762 of FIG. 12) are pushed by spring 761 and rotate so that the internal shutters are in the closed position.

The adapter also contains a barrel containing an alignment sleeve (not shown in FIG. 12). Alignment sleeve can to some extent freely float inside of the barrel, so it can optimally align two ferrules (not shown in FIG. 12) being engaged in physical, end-to-end contact from two opposite sides of the adapter 701.

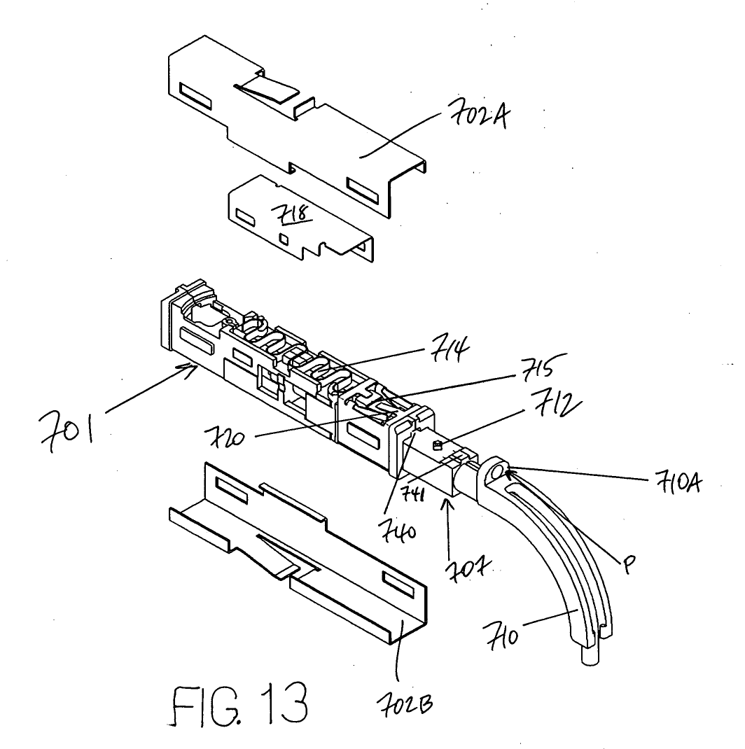

It should be understood that dual pin 712 (shown on FIG. 13) is an integral part of the Push-Push mechanism, since this dual pin 712 serves as an actuator of the mechanism. Each push-push spring clip 714 has two side arms 719 that keep flipper 715 in the middle position in line with the longitudinal axis of the adapter when push-push mechanism is not actuated. Push-push spring clip 714 also has a horizontally positioned arm 720 that presses flipper 715 down in order to maintain its constant contact with dual pin 712 (See FIG. 13) while performing the push-push action during insertion and withdrawal of connector 707 in or out with respect to the adapter 701.

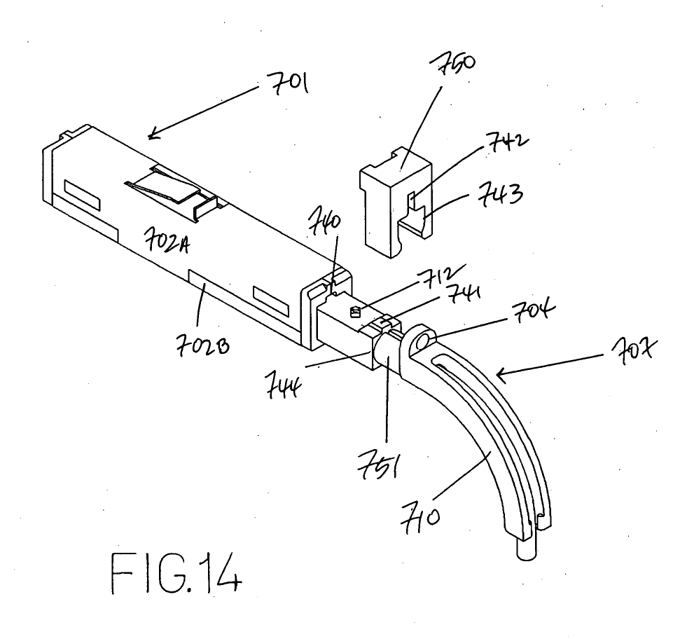

FIG. 14 shows connector 707 partially inserted into adapter 701, as shown in FIG. 13, the omission of cover 702 exposes push-push spring clips 714 having side arms 719, which serve to keep flippers 715 in the middle position, as shown in FIG. 13, until connector 707 is inserted far enough into adapter 701 that flipper 715 captures the square portion of pin 712 so as to retain connector 707 therewithin in engaged relation with adapter 701.

The insertion of connector 707 into this engaged and retained relationship with adapter 701 can be accomplished by applying force P, as shown in FIG. 13, to tab 710A by using a stylus, pen point, paper clip end or the like. Notch 740 provides clearance for pin 712 and enables proper alignment by receiving and accommodating detent 741 as it moves into the interior 706 of adapter 701.

FIG. 13 thus shows a perspective view of connector 707 initially, but not fully inserted into adapter 701 (outer shell not shown). This position is the beginning of the push-push process of securing the connector 707 in the mating position within the interior 706 of adapter 701.

As shown in FIG. 14, connector 707 is inserted partially (not fully) into opening 706 of one end of adapter 701. It is not inserted far enough for pin 712 to activate the engagement/disengagement mechanism within interior 706 of adapter 701. To prevent unintentional activation of the engagement/disengagement mechanism, spacer clip 750 can be inserted between boot 710 and rear connector end 744. Cutout region 743 of spacer clip 750 snaps onto boot neck 751. That way, because spacer clip 750 prevents connector 707 from being pushed into interior 706 of adapter 701, unintentional engagement and disengagement of connector 707 and adapter 701 is prevented. To prevent losing spacer clip 750, it should be loosely attached to connector 707 by wire, rubber band, string, rope, lanyard, filament, Velcro@, or the like (not shown) so that it is readily available when needed, without interfering with its locking function. Likewise, mating fasteners could be used to so attach spacer clip to the connector when not in use to prevent loss.

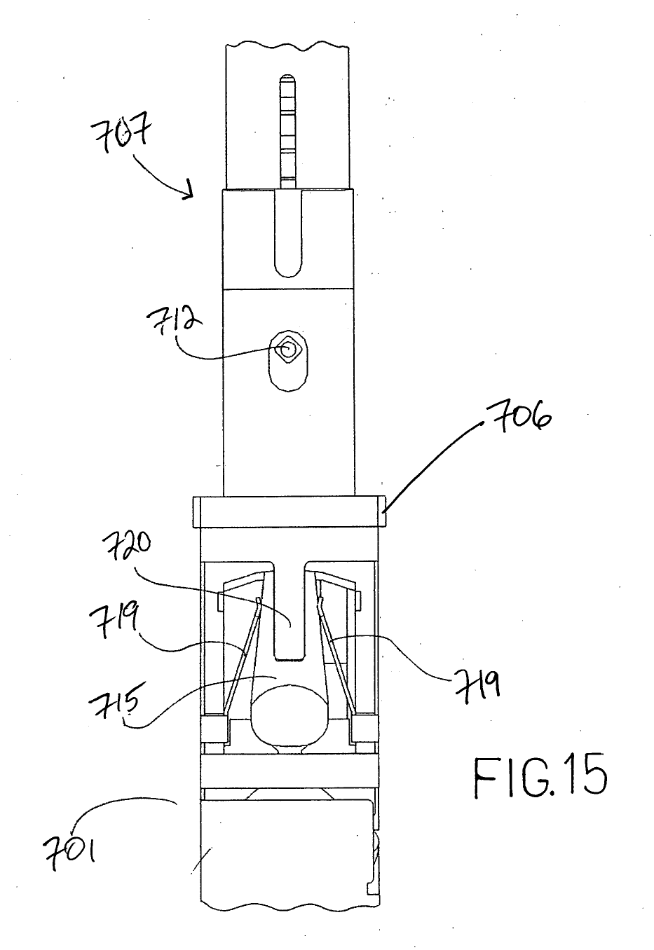

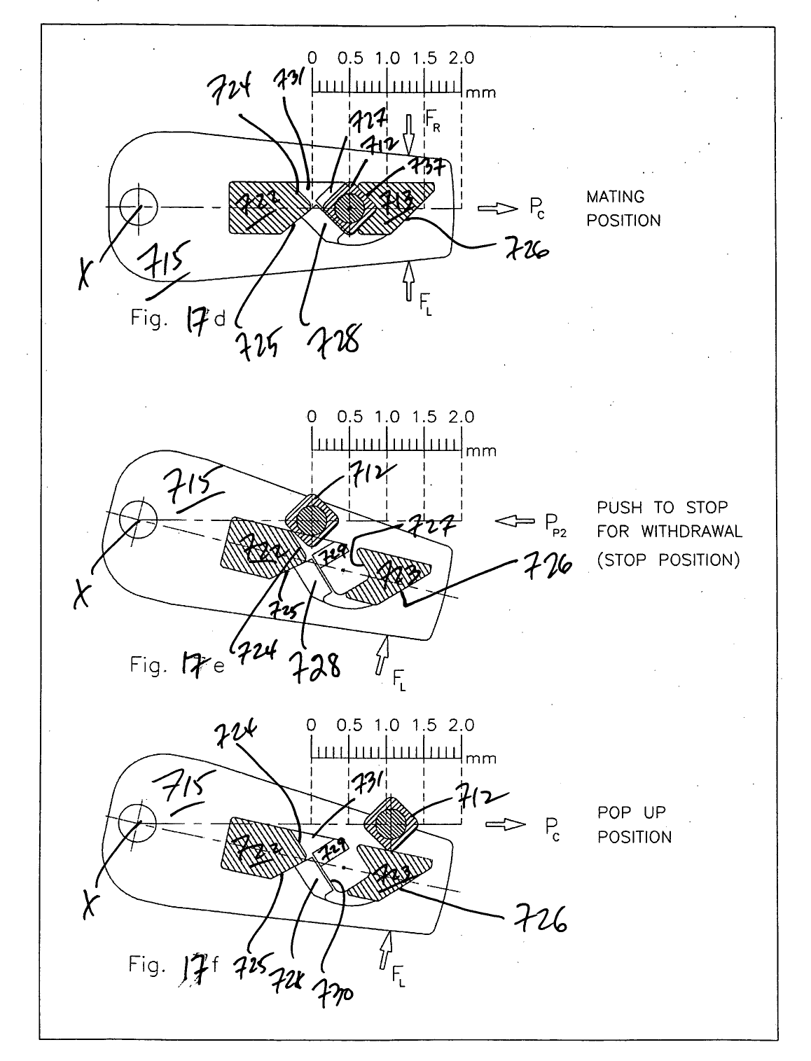

FIG. 15 shows an enlarged top view of the connector 707 in the process of being inserted into the interior of adapter 701. Dual pin 712 has not yet entered adapter interior 706. Side prongs 719 are in symmetrical position that keeps flipper 715 substantially in line with the longitudinal axis of the connector/adapter combination. Horizontal prong 720 presses flipper 715 down. This position is schematically shown on the FIG. 17a.

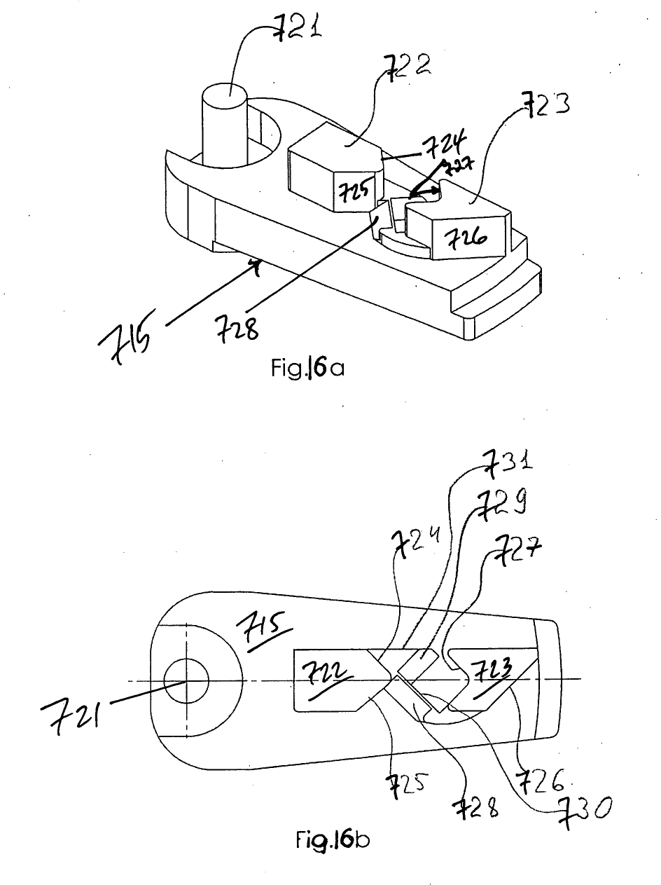

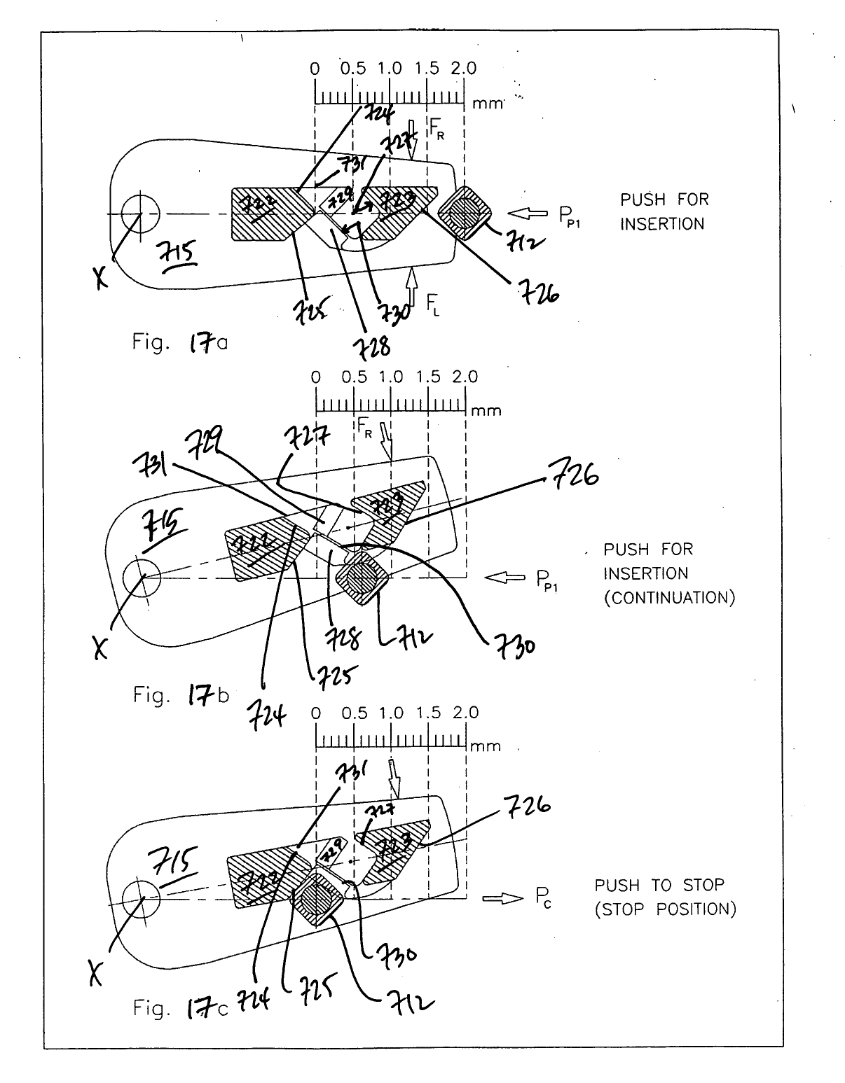

FIG. 16 shows flipper 715 in detail. FIG. 16A is an isometric view of the bottom surface of the flipper 715. FIG. 16B is a bottom view of the flipper 715. FIGS. 16A and 16B show that flipper 715 includes pin 721 providing a vertical axis about which flipper 715 swings or pivots to the left and to the right during the push-push operation. Also shown are inclined cam surfaces 724 and 725 of projection 722 and inclined cam surface 726 of projection 723 which urge flipper 715 to swing to the left or to the right based on direct contact with dual pin 712 of the connector 707, depending upon whether dual pin 712 (see FIG. 13) moves forward or backward respectively, during either the insertion or withdrawal operation.

As further shown in FIG. 17D, V-grooved surface 727 of projection 723 reliably keeps connector 707 in its mating position by holding squared portion of dual pin 712 with the force of the internal connector spring (not shown). Cams 728 and 729 facilitate flipper 715 to move over the ramped edges 730 and 731 while the non-ramped opposite vertical sides of those edges 730 and 731 prevent flipper 715 from sliding back and swinging in the wrong direction during insertion or withdrawal of connector 707 into or from adapter 701. As pushing force P_{P1} continues to move left in FIG. 17B until it reaches face 725 of projection 722 which as shown in FIG. 17C acts as a stop, while flipper 715 rotates upwardly about axis X.

FIGS. 17A through 17F schematically show the interaction between flipper 715 and dual pin 712 during insertion and withdrawal of connector 707 into or from adapter 710. On those diagrams arrows F_{R} and F_{L} represent right and left biasing forces created by two side legs 719 of the spring clip 714 (see FIG. 15). Those forces tend to keep flipper 715 in the neutral position when inactive. Arrows P_{P1} represent the insertion force when connector 707 moves into the adapter 701 during the first “push” action. Arrows P_{C} represent the force provided by the main connector spring (not shown in FIG. 17) which tends to either: (1) keep connector 707 in the mating position with the adapter 701 or, (2) pushes connector 707 out of the interior of adapter 701 after the second “push” action.

As shown in FIG. 17E, Arrow P_{P2} represents a force of a second “push” action. Each of FIGS. 17A through 17F also has a virtual 2 mm ruler which shows the relative position of flipper's different elements described earlier and both square and circular elements of dual pin 712 during each step of the insertion and withdrawal processes.

In reference to FIGS. 17A through 17C, in operation, connection is initiated by pushing connector 707 in the direction of arrow P_{P1} of FIG. 17A, until it is received in opening 706 of adapter 701 (FIG. 15). As square portion of pin 712 of connector 707 contacts and then slides along in contact with surface 726, it is guided along ramped cam surface 728 until it reaches the stopped position (FIG. 17C) by resting against angled surface 725. Further movement of connector 707 into the interior of adapter 701 is thus prohibited. Because flipper 715 is free to rotate about axis X, corresponding to pin 721 and hole 716, the spring force F_{R} provided by the side legs 719 of spring clip 714 is overcome and flipper 715 rotates clockwise as viewed in FIG. 17B, until pin 712 reaches the stop position against surface 725 as shown in FIG. 17C. When connector 707 is released and no longer pushed inwardly into the interior of adapter 701, biasing forces P_{C} of spring clip 714 tend to move flipper back to the center position of FIG. 17D, while ramped cam surfaces 728 and 729 tend to urge pin 712 downwardly into the mated position so as to abut surfaces 730 and 727 as shown in FIG. 17D by capturing square portion of pin 712 therein.

To unmate and withdraw connector 707 from adapter 701, connector 707 is again pushed inwardly along the longitudinal axis as viewed in FIGS. 17E and 17F and towards the interior of adapter 701. Pin 712 is then unseated from the mated position as follows. As inward force P_{P2} is applied, pin 712 moves up ramped surface 729 and along surface 724 (so that it is no longer captured between surfaces 730 and 727) and it slides along surface 731. Once pin 712 is freed, connector 707 can then be withdrawn from adapter 701. Because flipper 715 can rotate about axis X, the biasing force F_{L} is overcome and flipper 715 rotates counterclockwise as viewed in FIGS. 16E and 16F.

What is claimed:

1. A ferrule pak comprising:
A ferrule body having first and second ends and a longitudinal bore formed along its center;
An optical fiber running through said central bore of the ferrule body and being exposed at the first and second ends of the ferrule body; and,
At least one photonic device operably mounted directly to the first end of said ferrule body in aligned fashion with said optical fiber.

2. The ferrule pak of claim 1 further comprising at least two contacts proximate the first end of the ferrule body for electrically connecting with said photonic device.

3. The ferrule pak of claim 1 further comprising:
One or more coatings on said first end of said ferrule body interposed between said photonic device and said optical fiber.

4. The ferrule pak of claim 3 wherein said coating comprises an anti-reflective coating.

5. The ferrule pak of claim 3 wherein said coating comprises an absorptive coating.

6. The ferrule pak of claim 3 wherein said coating comprises a mirror.

7. The ferrule pak of claim 3 wherein said coating comprises a filter coating.

8. The ferrule pak of claim 1 wherein said ferrule body includes a metallized area that spans the epoxy junction between the fiber and the ferrule for hermetically sealing the photonic device against the environment.

9. The ferrule pak of claim 1 wherein one or more posts are interposed between the photonic device and the optical fiber to set the correct distance therebetween.

10. An active sub-assembly comprising:
A ferrule pak comprising a ferrule body having first and second ends and a longitudinal bore formed along its center;
An optical fiber running through said central bore of the ferrule body and being exposed at the first and second ends of the ferrule body;
At least one photonic device operably mounted directly to the first end of said ferrule body in aligned fashion with said optical fiber;
At least one ferrule pak holder with a central hole for receiving one end of said ferrule body therein; and,
at least two contacts operably attached to said holder for electrical connection of said photonic device thereto.

11. An active sub-assembly comprising:
A ferrule pak comprising a ferrule body having first and second ends and a longitudinal bore formed along its center;
An optical fiber running through said central bore of the ferrule body and being exposed at the first and second ends of the ferrule body;
At least one photonic device operably mounted directly to the first end of said ferrule body in aligned fashion with said optical fiber;
At least one ferrule pak holder with a central hole for receiving one end of said ferrule body therein;
Said holder comprising multiple layers of ceramic material having a concentric central passageway through said layers for receiving one end of said ferrule pak; and,
A hermetic sealing assembly operably associated with said ferrule body and said holder for sealing said photonic device from the environment.

12. The hermetic sealing assembly of claim 11 further comprising:
Said ferrule pak having a first metallic ring about the outer periphery of said ferrule body;
A second metallic ring about the periphery of the central passageway at least one layer of the holder aligned with said first metallic ring of said ferrule pak when said holder and ferrule pack are assembled together;
A third metallic ring about the periphery of the central passageway of at least one layer of the holder;
A metallic cap outside of said layers of the holder;
At least two contacts operably attached to said holder for electrical connection of said photonic device thereto;
A first metallic ring of said ferrule pak sealingly attached to said second metallic ring; and,
Said metallic cap being sealingly attached to said third metallic ring.

13. The hermetic sealing assembly of claim 12 further comprises:
The first metallic ring being soldered to the second metallic ring; and,
The metallic cap being soldered to the third metallic ring.

14. The active sub-assembly of claim 11 further comprising ferrule pak alignment means comprising:
A flat face on one end of the ferrule body; and
A flat side on the central passageway of at least one of said layers of the ferrule pak holder and aligned to the flat face on the ferrule body, so that the ferrule body is attached to the ferrule body holder in only the correct orientation.

15. An active sub-assembly comprising:
A photonic device;
A ceramic board;
Said photonic device operably connected to said board;
A ferrule sub-assembly having an optical fiber in a longitudinal bore and a cavity for receiving the photonic device; and,
Said board and said ferrule sub-assembly being moveable horizontally and vertically with respect to each other for active alignment of said photonic device with respect to said fiber.

16. An active modular optoelectronic component comprising:
At least one active subassembly;
Said active subassembly comprising a photonic device and a first ferrule at a first end;
A shield member substantially surrounding at least a portion of said active subassembly;
An adapter housing having an opening at a first end for receipt of a second ferrule;
Said active subassembly being operably connected to a second end of said adapter housing;
An alignment member operably associated with said adapter housing and interposed between said first and second ferrules; and,
Said shield and said adapter being attached together.

17. The active modular optoelectronic component of claim 16 wherein said photonic device comprises a light emitting device.

18. The active modular optoelectronic component of claim 16 wherein said photonic device comprises a light detecting device.

19. The modular active optoelectronic component of claim 16 wherein said optoelectronic component comprises two active subassemblies.

20. The active modular optoelectronic component of claim 19 wherein said two active subassemblies comprise a light emitting device and a light detecting device.

21. The active modular optoelectronic component of claim 19 wherein said two active subassemblies comprise two light emitting devices.

22. The active modular optoelectronic component of claim 19 wherein said two active subassemblies comprise two light detecting devices.

23. The active modular optoelectronic component of claim 16 wherein said active subassembly is sized and shaped so as to be interchangeable with other active subassemblies.

24. The active modular optoelectronic component according to claim 16 wherein said component further comprises an internal shutter mechanism.

25. The active modular optoelectronic component according to claim 16 wherein said component further comprises a Push-Push interconnect mechanism operably associated with said adapter housing.

26. An active subassembly for the adapter housing of an active optical modular optoelectronic component comprising:
A printed circuit board;
A photonic device operably mounted to the circuit board;
A ferrule subassembly including a ferrule, operably mounted to the circuit board and operably connected to said photonic device;
An adapter housing having a first open end; and,
Said adapter housing configured to receiving said ferrule subassembly in aligned relationship.

27. The active subassembly of claim 26 wherein the ferrule has a diameter of less than 1 mm.

28. A ferrule pak for an active modular optoelectronic component comprising:
A substantially cylindrical ceramic body having a central bore along its length;
An optic fiber operably affixed within said central bore and exposed at an active end and a passive end of said ceramic body;
At least one metallic contact operably applied at the active end of said ceramic body; and,
A photonic device operably connected to said contact and said fiber at said active end of said ceramic body.

29. The ferrule of claim 28 wherein one or more spacers are interposed between the photonic device and said fiber at the active end of the ceramic body.

30. The ferrule of claim 28 wherein one or more coatings are interposed between the photonic device and said fiber at the active end of the ceramic body.

31. The ferrule of claim 28 wherein a metallic ring is interposed between the photonic device and said fiber at the active end of the ceramic body so as to provide a hermetic barrier between the photonic device and the environment.

32. A ferrule subassembly for an active modular optoelectronic component comprising:
A substantially cylindrical ceramic body having a central bore along its length;
An optic fiber operably affixed within said central bore and exposed at each end of said ceramic body;
At least one first metallic contact located at a first end of said ceramic body;
At least one ceramic plate having a transverse central bore formed therein;
Said ceramic plate having second metallic contacts operably affixed thereto;
Said ceramic body joined to said ceramic plate through said central bore, such that said first metallic contacts are operably connected to said second metallic contacts; and
A photonic device operably connected to said first metallic contacts and positioned in close proximity to said fiber at said first end of said ceramic body.

33. The ferrule assembly of claim 32 wherein said assembly further includes hermetic sealing of said photonic device from the environment comprising:
A first metallic ring located on the circumference of the ceramic body;
A second metallic ring located on the periphery of the central bore of the ceramic plate; and,
The first metallic ring being attached to the second metal ring so as to seal said photonic device.

34. A ferrule subassembly for an active fiber optic component comprising:
A substantially cylindrical ceramic body having a central bore along its length and active and passive ends;
An optic fiber operably affixed within said central bore and exposed at each end of said ceramic body;
At least one first metallic contact deposited at the active end of said ceramic body;
A plurality of ceramic plates, each of which having a concentric transverse central bore formed therein for receiving said ceramic body therein;
Said ceramic plates having second metallic contacts operably affixed thereto;
Said ceramic body operably joined to said ceramic plates through said central bores, such that said first metallic contacts are operably connected to said second metallic contacts; and,
A photonic device operably connected to said first metallic contacts and said fiber at said first end of said ceramic body.

35. The ferrule assembly of claim 34 wherein said assembly further includes hermetic sealing of said photonic device from the environment comprising:
A first metallic ring operably placed on the circumference of the ceramic body;
A second metallic ring operably placed on the periphery of the central bore of one of said plurality of ceramic plates;
The first metallic ring being operably attached to the second metal ring;
A third metallic ring attached about the periphery of the central bore of one of the plurality of ceramic plates; and
A metallic cap operably attached to the third metallic ring so as to seal said photonic device.

36. A ferrule subassembly for an active fiber optic component comprising:
A ceramic body having a optic fiber affixed within a central bore along its length and exposed at the active and passive ends of the body;
The body being securely affixed to a first ceramic plate through a central bore;
A photonic device operably affixed to contacts operably associated with a second ceramic plate;
The body and the first ceramic plate including a chamber for receipt of the photonic device in close proximity to the fiber at the end of the body; and,
The second ceramic plate is moveable with respect to the first ceramic plate for active alignment thereof.

37. An optical interface having a footprint that is less than 43 mm².

38. An optical interface sized such that 6 channels can be used in the same footprint as a SFP optical interface.

39. An active subassembly to be connected to a PC board comprising:
A ferrule pak having an active end and a passive end;
Said ferrule pak comprising an active component operably attached in close proximity to the active end of the ferrule pak;
A barrel having a longitudinal interior bore therethrough for receipt of said ferrule pak therein;
An end cap for receipt of said active end of said ferrule pak and said active component and operatively connecting to the barrel;
An alignment device interposed between the barrel and the ferrule pak within the interior bore of the barrel; and,
Said end cap being operably mounted to said board.
